(19) United States
(12) Patent Application Publication
(10) Pub. No.: US 2026/0326849 A1
(43) Pub. Date: Oct. 22, 2026

(54) SCOOTER

(71) Applicant: Radical Sportech LLC, Taipei City (TW)

(72) Inventor: Neil Owen, Dongguan City (CN)

(21) Appl. No.: 19/182,786

(22) Filed: Apr. 18, 2025

(51) Int. Cl. B62K 5/05; B62K 5/08; B62K 21/22

(52) U.S. Cl. CPC B62K 5/05; B62K 5/08; B62K 21/22

(57) ABSTRACT

A scooter is provided, wherein the scooter includes: a main body including a deck, a front end portion, a rear end portion, and wheels disposed on the front and rear end portions, the front end portion and the rear end portion being respectively connected to opposing ends of the deck, the deck including a recess and a supporting member received in the recess, and the supporting member including a connection end portion; a handle bar connected to the front end portion and including a grip; and a locking device releasably and adjustably connected to the handle bar and including a connecting portion; wherein the supporting member is removable from the recess and connected to the connecting portion by the connection end portion such that the supporting member extends laterally relative to the handle bar and is spaced apart from the deck to form a seat.

### BACKGROUND OF THE INVENTION

### Field of the Invention

The present invention relates to a scooter, particularly to a transformable scooter.

### Description of the Prior Art

Scooters are a very common means of transportation in daily life. Most scooters are designed only for standing use. For long-term users, the lack of a seat may lead to fatigue and affect riding comfort.

In addition, although some scooters are equipped with seats (e.g., scooters for children), these often require an additional seat to be assembled or fixed to the scooter. The seat cannot be flexibly adjusted according to user needs, and when not in use, the seat cannot be directly stored in the main body of the scooter. As a result, the overall structure is complex, installation and removal are cumbersome, the volume is large, and portability and storage are inconvenient.

The present invention is, therefore, arisen to obviate or at least mitigate the above-mentioned disadvantages.

### SUMMARY OF THE INVENTION

The main object of the present invention is to provide a scooter which can switch between a standing mode and a sitting mode. The seat does not require additional assembly, the components are simple, the structure is compact, the packaging volume is small, installation and removal are easy, and the seat height is adjustable.

To achieve the above and other objects, a scooter is provided, wherein the scooter includes: a main body including a deck, a front end portion, a rear end portion and a plurality of wheels, the front end portion and the rear end portion being respectively connected to opposing ends of the deck, the plurality of wheels being respectively disposed on the front end portion and the rear end portion, the deck including a recess and a supporting member, the supporting member being received in the recess, and the supporting member including a connection end portion; a handle bar connected to the front end portion and including a grip; and a locking device releasably and adjustably connected to the handle bar and including a connecting portion; wherein the supporting member is removable from the recess and connected to the connecting portion by the connection end portion such that the supporting member extends laterally relative to the handle bar and is spaced apart from the deck to form a seat.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a standing mode of an exemplary embodiment of the present invention;

FIGS. 2 and 3 are partial exploded views of an exemplary embodiment of the present invention;

FIG. 4 is a perspective view of a sitting mode of an exemplary embodiment of the present invention;

FIG. 5 is a partial enlarged view of an exemplary embodiment of the present invention; and

FIGS. 6 and 7 are partial enlarged cross-sectional views of an exemplary embodiment of the present invention.

### DETAILED DESCRIPTION OF THE PREFERRED EMBODIMENTS

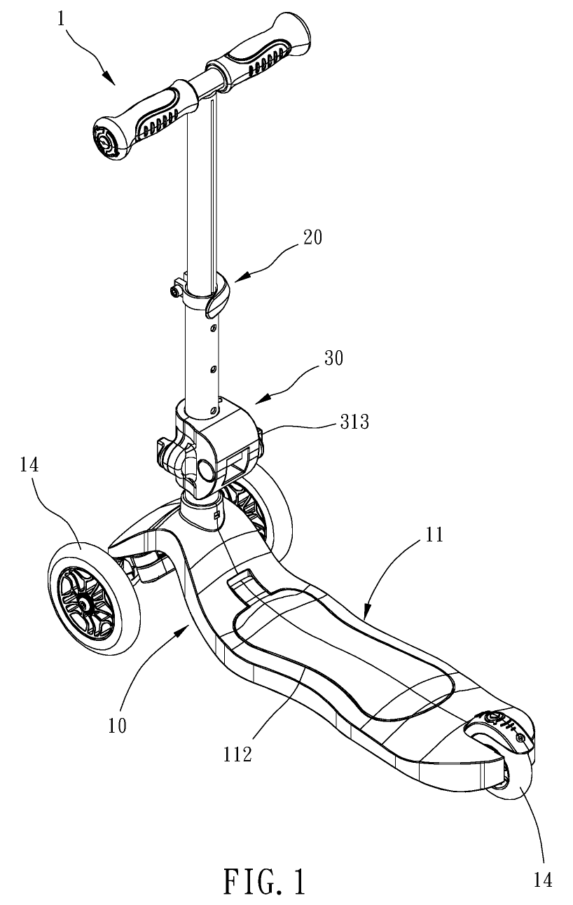

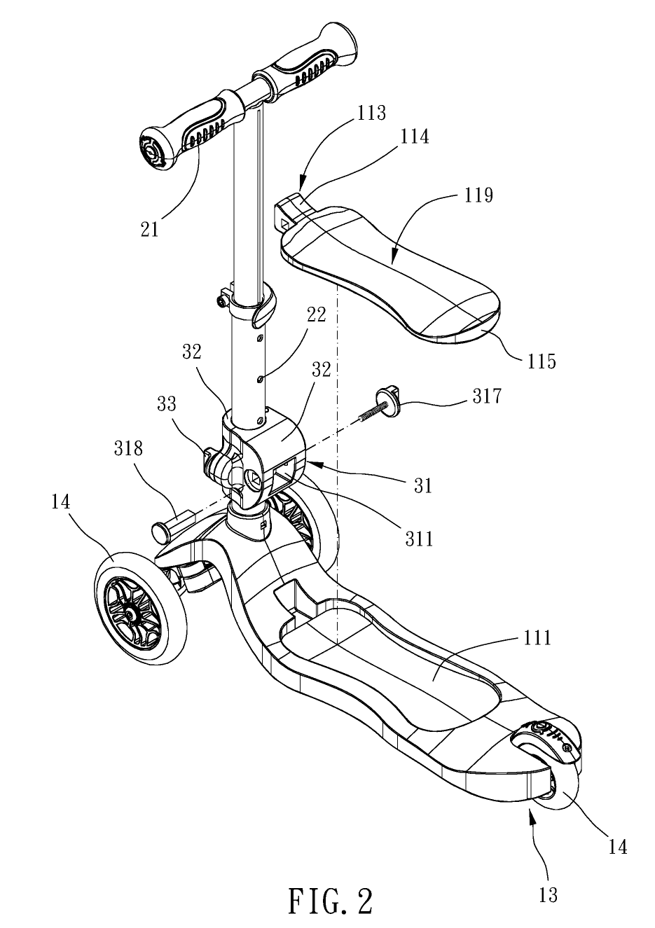

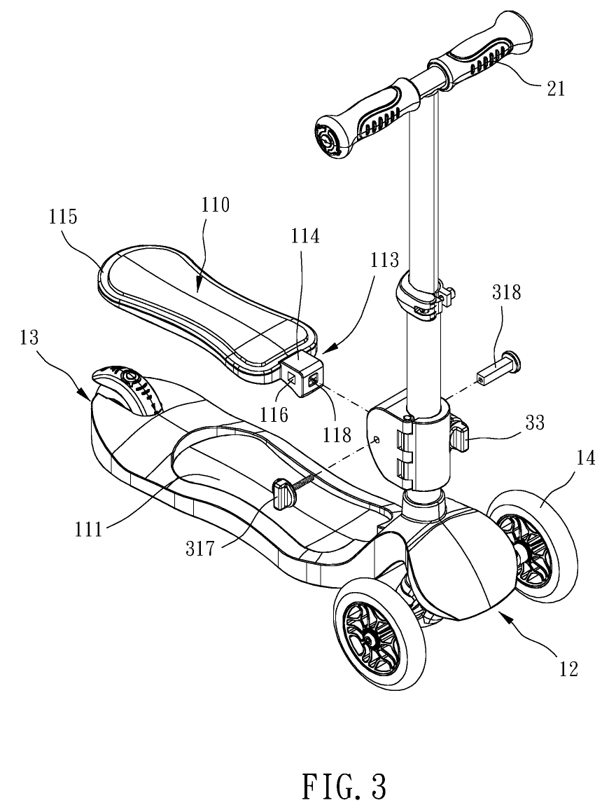

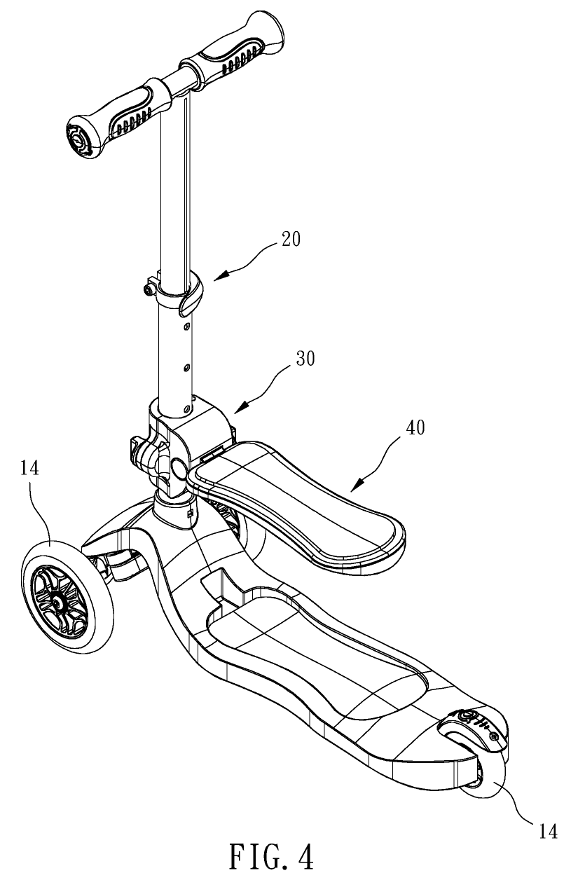

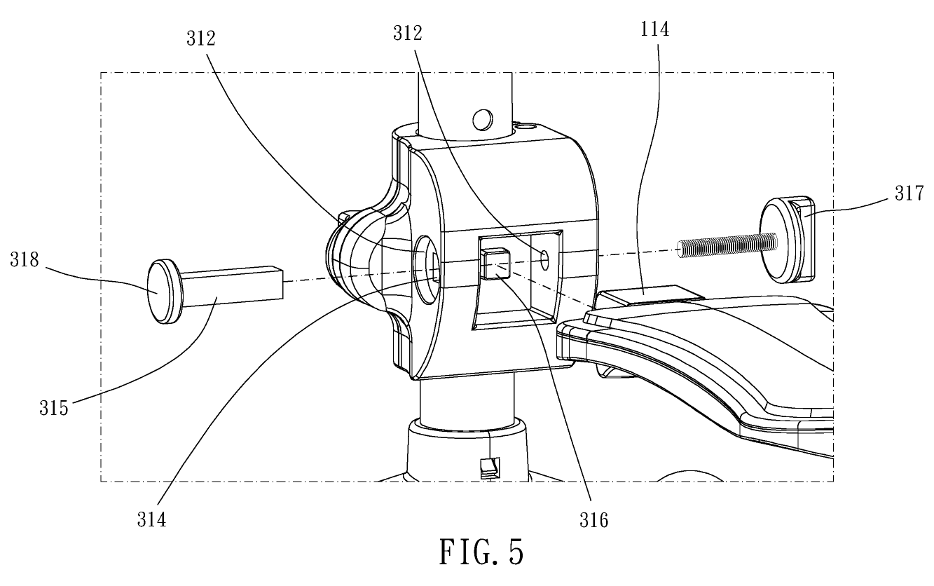

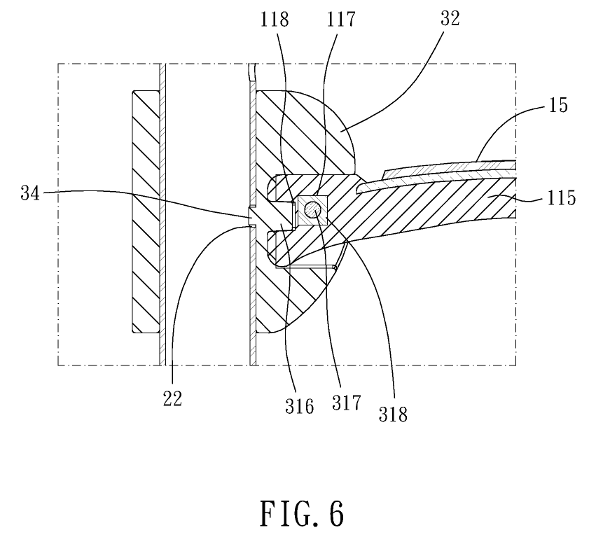

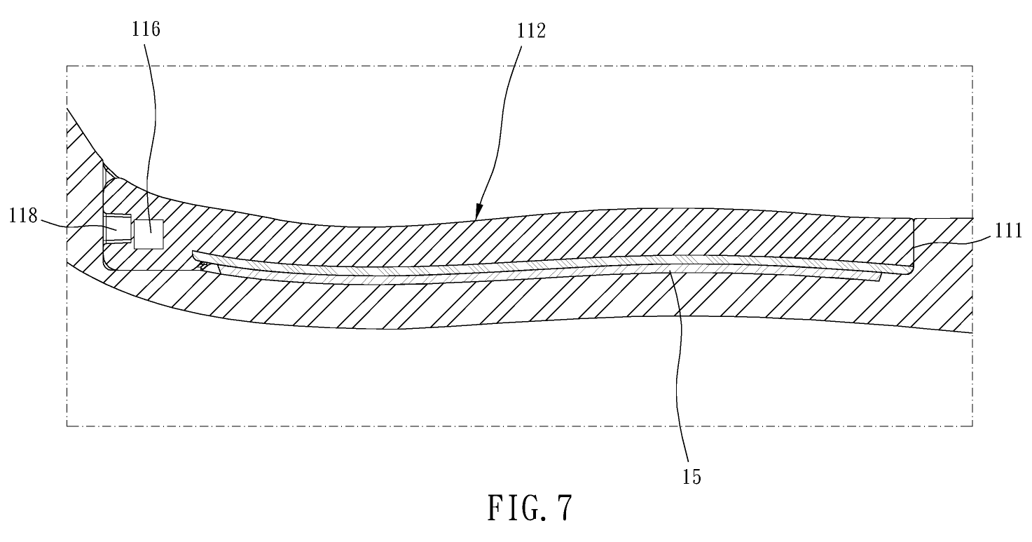

Please refer to FIGS. 1-7 for an exemplary embodiment of the present invention. A scooter 1 of the present invention includes a main body 10, a handle bar 20, and a locking device 30.

The main body 10 includes a deck 11, a front end portion 12, a rear end portion 13, and a plurality of wheels 14. The front end portion 12 and the rear end portion 13 are respectively connected to opposing ends of the deck 11. The plurality of wheels 14 are respectively disposed on the front end portion 12 and the rear end portion 13. The deck 11 includes a recess 111 and a supporting member 112. The supporting member 112 is received in the recess 111 and includes a connection end portion 113. The handle bar 20 is connected to the front end portion 12 and includes a grip 21. The locking device 30 is releasably and adjustably connected to the handle bar 20 and includes a connecting portion 31. The supporting member 112 is removable from the recess 111 and connected to the connecting portion 31 by the connection end portion 113 such that the supporting member 112 extends laterally relative to the handle bar 20 and is spaced apart from the deck 11 to form a seat 40. As such, a portion of the deck 11 can serve as the seat 40, enabling the scooter 1 to switch between a standing mode and a sitting mode without requiring additional seat assembly. The components are simple, the structure is compact, the packaging volume is small, installation and removal are easy, and the seat height is adjustable.

The connection end portion 113 includes a plug 114, and the connecting portion 31 includes an insertion slot 311. When the connection end portion 113 is connected to the connecting portion 31, the plug 114 is inserted in the insertion slot 311. The rear end portion of the supporting member 112 is suspended above the recess 111 without any structural support on the deck 11. Preferably, the plug 114 and the insertion slot 311 are non-circular and non-rotatably engaged with each other. The supporting member 112 further includes a plate member 115 connected to the connection end portion 113, and the connection end portion 113 has a thickness greater than a thickness of the plate member 115, thereby providing strong engagement and stability for the seat 40.

The plug 114 further includes a positioning hole 116. The connecting portion 31 further includes an insertion hole 312 and a positioning member 313. The insertion hole 312 is in communication with the insertion slot 311. The positioning member 313 is inserted in the insertion hole 312 and the positioning hole 116 to increase structural stability. The positioning hole 116 includes a non-circular section 117, the insertion hole 312 includes a non-circular section 314, and the positioning member 313 includes a non-circular body section 315. The non-circular body section 315 is non-rotatably inserted in the non-circular section 314 of the insertion hole 312 and the non-circular section 117 of the positioning hole 116 to enhance the stability of the seat 40. Preferably, the plug 114 includes an engaging slot 118, a projection 316 projects on a wall of the insertion slot 311, and the projection 316 is engaged in the engaging slot 118. The engaging slot 118 and the projection 316 are non-circular and non-rotatably engaged with each other to enhance the engagement strength and stability of the connection end portion 113. Specifically, the positioning member 313 further includes a male locking member 317 and a female locking member 318. The female locking member 318 includes the non-circular body section 315. The male locking member 317 and the female locking member 318 are screwed to each other, effectively fastening and holding the plug 114, and facilitating installation, removal, replacement and maintenance.

The locking device 30 further includes two clamping members 32 and a fastener 33 (such as a bolt with a knob). Opposite sides of the two clamping members 32 are rotatably connected to each other, and the fastener 33 connects another opposite sides of the two clamping members 32 so that the two clamping members 32 clamp the handle bar 20. Preferably, the handle bar 20 further includes at least one (preferably more than one) engaging hole 22. The locking device 30 further includes a protrusion 34. The protrusion 34 is positioned in the at least one engaging hole 22 to stabilize the locking device 30 and prevent undesired movement. By loosening the fastener 33, the height of the locking device 30 and the seat 40 can be adjusted.

In this embodiment, the supporting member 112 further includes a tread side 119 and a sitting side 110 opposite to each other. The supporting member 112 is received in the recess 111 with the sitting side 110 facing the bottom of the recess 111. When the connection end portion 113 is connected to the connecting portion 31, the sitting side 110 faces away from the bottom of the recess 111, ensuring the user sits on a clean surface. Preferably, the supporting member 112 further includes a flexible layer 15. When the connection end portion 113 is connected to the connecting portion 31, the flexible layer 15 faces away from the bottom of the recess 111. The flexible layer 15 may be a single-layer or multi-layer structure and provides a comfortable sitting experience. When the supporting member 112 is received in the recess 111, the flexible layer 15 can buffer shocks and provide good riding comfort.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A scooter including:
a main body including a deck, a front end portion, a rear end portion and a plurality of wheels, the front end portion and the rear end portion being respectively connected to opposing ends of the deck, the plurality of wheels being respectively disposed on the front end portion and the rear end portion, the deck including a recess and a supporting member, the supporting member being received in the recess, and the supporting member including a connection end portion;
a handle bar connected to the front end portion and including a grip; and
a locking device releasably and adjustably connected to the handle bar and including a connecting portion;
wherein the supporting member is removable from the recess and connected to the connecting portion by the connection end portion such that the supporting member extends laterally relative to the handle bar and is spaced apart from the deck to form a seat.

2. The scooter of claim 1, wherein the connection end portion includes a plug, the connecting portion includes an insertion slot, and when the connection end portion is connected to the connecting portion, the plug is inserted in the insertion slot.

3. The scooter of claim 2, wherein the plug includes a positioning hole, the connecting portion further includes an insertion hole and a positioning member, the insertion hole is in communication with the insertion slot, and the positioning member is inserted in the insertion hole and the positioning hole.

4. The scooter of claim 3, wherein the positioning hole includes a non-circular section, the insertion hole includes a non-circular section, the positioning member includes a non-circular body section, and the non-circular body section is non-rotatably inserted in the non-circular section of the insertion hole and the non-circular section of the positioning hole.

5. The scooter of claim 2, wherein the plug includes an engaging slot, a projection projects on a wall of the insertion slot, and the projection is engaged in the engaging slot.

6. The scooter of claim 5, wherein the engaging slot and the projection are non-circular and non-rotatably engaged with each other.

7. The scooter of claim 1, wherein the locking device further includes two clamping members and a fastener, opposite sides of the two clamping members are rotatably connected to each other, and the fastener secures another opposite sides of the two clamping members such that the two clamping members clamp the handle bar.

8. The scooter of claim 4, wherein the plug includes an engaging slot, a projection projects on a wall of the insertion slot, and the projection is engaged in the engaging slot; the engaging slot and the projection are non-circular and non-rotatably engaged with each other; the locking device further includes two clamping members and a fastener, opposite sides of the clamping members are rotatably connected to each other, and the fastener secures another opposite sides of the clamping members such that the two clamping members clamp the handle bar; the plug and the insertion slot are non-circular and non-rotatably engaged with each other; the supporting member further includes a plate member, the plate member is connected to the connection end portion, and the connection end portion has a thickness greater than a thickness of the plate member; the positioning member further includes a male locking member and a female locking member, the female locking member includes the non-circular body section, and the male locking member and the female locking member are screwed to each other; the supporting member further includes a flexible layer, and when the connection end portion is connected to the connecting portion, the flexible layer faces away from the bottom of the recess.

9. The scooter of claim 1, wherein the handle bar further includes at least one engaging hole, the locking device further includes at least one protrusion, and the protrusion is positioned in the at least one engaging hole.

10. The scooter of claim 1, wherein the supporting member further includes an tread side and sitting side opposite to each other, the supporting member is received in the recess with the sitting side facing the bottom of the recess, and when the connection end portion is connected to the connecting portion, the sitting side faces away from the bottom of the recess.
